(19) United States
(12) Patent Application Publication
(10) Pub. No.: US 2026/0214712 A1
(43) Pub. Date: Jul. 23, 2026

(54) CCA THRESHOLD DETERMINATION SYSTEM, CCA THRESHOLD DETERMINATION DEVICE, CCA THRESHOLD DETERMINATION METHOD, AND CCA THRESHOLD DETERMINATION PROGRAM

(71) Applicant: NTT. Inc, Tokyo (JP)

(72) Inventors: Hanae OTANI, Musashino-shi, Tokyo (JP); Hirantha ABEYSEKERA, Musashino-shi, Tokyo (JP); Yusuke ASAI, Musashino-shi, Tokyo (JP); Yasushi TAKATORI, Musashino-shi, Tokyo (JP)

(73) Assignee: NTT, Inc., Tokyo (JP)

(21) Appl. No.: 19/142,640

(22) PCT Filed: Jan. 12, 2023
(86) PCT No.: PCT/JP2023/000623

§ 371 Date: Jun. 24, 2025

(51) Int. Cl. H04W 74/0816; H04B 17/318

(52) U.S. Cl. CPC H04W 74/0816; H04B 17/318

(57) ABSTRACT

Each of the wireless devices transmits the frame in a case where the absence of the frame having the reception power value equal to or greater than the transmission CCA threshold can be confirmed. The wireless device detects an environment for receiving a frame regardless of execution of the carrier sensing, and sets a reception CCA threshold on the basis of the reception environment. A frame having a reception power value less than the reception CCA threshold is ignored, and only a frame having a reception power value equal to or greater than the reception CCA threshold is decoded. On the basis of the reception environment, the reception CCA threshold is set to a value at which a frame addressed to its own BSS is easily decoded and a frame addressed to another BSS is easily ignored.

### TECHNICAL FIELD

The present disclosure relates to a CCA threshold determination system, a CCA threshold determination device, a CCA threshold determination method, and a CCA threshold determination program.

### BACKGROUND ART

In the field of wireless communication, a carrier sensing method is widely known as a technology for avoiding communication collision. In this method, a wireless device attempting to start the transmission first checks whether or not a carrier (carrier wave) is transmitted from another device, and starts the transmission processing in a case where the absence of the carrier is confirmed. At this time, whether or not there is the carrier is determined by whether or not the carrier with an intensity exceeding a preset clear channel assessment (CCA) threshold is received.

In recent years, since a large number of wireless devices are densely disposed, it is common that service areas of a plurality of basic service sets (BSSs) overlap. In the IEEE802.11ax standard, a Spatial Reuse (SR) function is added for the purpose of obtaining a high communication quality under such circumstances.

In this function, a BSS color is defined for each BSS. At the time of carrier sensing, a base station and a terminal can identify whether a frame is addressed to its own BSS or addressed to another BSS on the basis of the BSS color included in the received frame. Then, according to this function, the base station and the terminal set the CCA threshold to a default value Tha in a case where the frame is addressed to its own BSS, and change the CCA threshold to an increase value Thb (>Tha) in a case where the frame is addressed to another BSS.

The base station and the terminal can more sensitively detect the presence of a carrier with a lower CCA threshold. Therefore, according to the above-described function, the base station and the terminal detect communication in its own BSS with high sensitivity and detect communication in another BSS with low sensitivity by performing carrier sensing prior to transmission. That is, according to the above-described SR function, the base station and the terminal can perform carrier sensing so as not to unreasonably interfere with communication in its own BSS and not to excessively react to communication in another BSS. Therefore, this function is effective for avoiding a problem of a so-called exposed terminal related to a loss of a transmission opportunity. Note that in a case where a wireless communication system to be applied is Wi-Fi (registered trademark), the base station corresponds to an access point.

### CITATION LIST

### Non Patent Literature

Non Patent Literature 1: IEEE 802.11ax Musen ran ni okeru ko yusen furemu hogo gijutsu no ichi kento (in Japanese) (A Study of Protection Method for Prioritized Frames in OBSS Environment for IEEE 802.11ax Wireless LANs), Otani, and others, IEICE Society Conference, 2021

Non Patent Literature 2: IEEE 802.11ax Musen ran ni okeru ko yusen furemu hogo shuho (in Japanese) (A Protection Method for Prioritized Frames in OBSS Environment for IEEE 802.11ax Wireless LANs), Otani, and others, IEICE General Conference, 2021

Non Patent Literature 3: IEEE 802.11ax Musen ran ni okeru ko yusen furemu soshin sokushin hogo gijutsu (in Japanese) (A Boosting and Protection Method for Prioritized Frames in OBSS Environment for IEEE 802.11ax Wireless LANs), Otani, and others, IEICE General Conference, 2022

### SUMMARY OF INVENTION

### Technical Problem

Non Patent Literatures 1 to 3 disclose a technology for protecting a high-priority frame communication on the premise of the SR function described above. For example, Non Patent Literatures 1 and 2 disclose a technology for changing the CCA threshold from the increase value Thb to a smaller value in a case where the high-priority frame addressed to another BSS is detected at the time of carrier sensing prior to the start of transmission. According to this technology, in addition to the frame in its own BSS, the high-priority frame in another BSS is detected with high sensitivity by performing carrier sensing. As a result, the start of data transmission that collides with the high-priority frame in another BSS is avoided, and thus the high-priority frame is protected.

However, the technologies disclosed in Non Patent Literatures 1 to 3 described above merely relate to threshold setting of the carrier sensing prior to transmission. That is, it relates to a CCA threshold when a wireless device such as a base station or a terminal functions as a transmission station, more specifically, a CCA threshold used by a transmission station in which a transmission request occurs to determine whether or not the transmission can be performed.

For example, the following situation is assumed.
A plurality of terminals and a base station are present in its own BSS.
At least one of a plurality of the terminals is a terminal that transmits a high-priority frame. Hereinafter, the terminal that transmits the high-priority frame is referred to as a “quality of service (QoS) terminal”.
The QoS terminal is also present in another BSS.

By the way, as a normal function, the wireless device that performs carrier sensing ignores a wireless signal with a value less than the CCA threshold regardless of the presence or absence of a transmission request, and receives and decodes the wireless signal with an intensity equal to or greater than the CCA threshold. Assuming that the base station determines the CCA threshold at the time of reception by the methods described in Non Patent Literatures 1 and 2 above on the basis of the above-described assumption, the base station determines the necessity of reception for all the terminals in its own BSS and the QoS terminals in another BSS using the CCA threshold smaller than the increase value Thb, for example, the default value Tha.

In this case, the base station handles all terminals in its own BSS and QoS terminals in another BSS in the same manner with regard to reception. Then, once the base station starts decoding processing of the reception frame, even when the high-priority frame is transmitted from the QoS terminal in its own BSS thereafter, the frame is not received by the base station.

Non Patent Literature 3 discloses that the QoS terminal changes the CCA threshold used at the time of carrier sensing to a value larger than the default value Tha, and that the QoS terminal gives a transmission output larger than a default output to the high-priority frame. According to this technology, it is possible to increase a probability that the QoS terminal obtains a transmission opportunity, and it is possible to increase a probability that the transmission of the high-priority frame is successful. However, when the base station on a side receiving the frame is decoding other reception frames, this transmission is also not be performed.

As described above, the conventional technology in which the transmission station appropriately sets the CCA threshold used for determining whether or not transmission can be performed improves a communication quality in an environment where the wireless devices are densely located, but there is still room for improvement in order to further improve the quality.

The present disclosure has been made in view of the above problems, and a first object of the present disclosure is to provide a CCA threshold determination system that separately sets a transmission CCA threshold used for carrier sensing at the time of transmission, and a reception CCA threshold used for selecting a reception frame, in order to achieve a high communication quality in an environment where the wireless devices are densely located. Note that the reception CCA threshold may be determined and reflected in the transmission CCA threshold. The same applies to other aspects.

Furthermore, a second object of the present disclosure is to provide a CCA threshold determination device that separately sets a transmission CCA threshold used for carrier sensing at the time of transmission, and a reception CCA threshold used for selecting a reception frame, in order to achieve a high communication quality in an environment where the wireless devices are densely located.

A third object of the present disclosure is to provide a CCA threshold determination method for separately setting a transmission CCA threshold used for carrier sensing at the time of transmission, and a reception CCA threshold used for selecting a reception frame, in order to achieve a high communication quality in an environment where the wireless devices are densely located.

A fourth object of the present disclosure is to provide a CCA threshold determination program for separately setting a transmission CCA threshold used for carrier sensing at the time of transmission, and a reception CCA threshold used for selecting a reception frame, in order to achieve a high communication quality in an environment where the wireless devices are densely located.

### Solution to Problem

In order to achieve the above-described objects, according to a first aspect, there is desirably provided a CCA threshold determination system that determines a CCA threshold used in a wireless communication system including a plurality of wireless devices configured by base stations or terminals,
in which at least one of the wireless devices is configured to execute:
processing of performing carrier sensing to determine presence or absence of a frame having a reception power value equal to or greater than a transmission CCA threshold when a transmission request occurs;
processing of transmitting a frame in a case where the absence of the frame having the reception power value equal to or greater than the transmission CCA threshold is confirmed as a result of the carrier sensing;
reception environment detection processing of detecting an environment for receiving a frame regardless of execution of the carrier sensing;
threshold setting processing of setting a reception CCA threshold on the basis of the reception environment; and
processing of ignoring a frame having a reception power value less than the reception CCA threshold and decoding the frame having a reception power value equal to or greater than the reception CCA threshold, and
the threshold setting processing includes processing of setting, as the reception CCA threshold, a value at which a frame addressed to its own BSS is easily decoded and a frame addressed to another BSS is easily ignored, on the basis of the reception environment.

Furthermore, according to a second aspect, there is desirably provided a CCA threshold determination device that determines a CCA threshold used in a wireless device configured by a base station or a terminal, the CCA threshold determination device being configured to execute:
processing of performing carrier sensing to determine presence or absence of a frame that reaches the wireless device using a reception power value equal to or greater than a transmission CCA threshold when a transmission request occurs in the wireless device;
processing of permitting the wireless device to transmit a frame in a case where the absence of the frame having the reception power value equal to or greater than the transmission CCA threshold is confirmed as a result of the carrier sensing;
reception environment detection processing of detecting an environment where the wireless device receives a frame regardless of execution of the carrier sensing;
threshold setting processing of setting a reception CCA threshold on the basis of the reception environment; and
processing of causing the wireless device to ignore a frame having a reception power value less than the reception CCA threshold and decode the frame having a reception power value equal to or greater than the reception CCA threshold, in which the threshold setting processing includes processing of setting, as the reception CCA threshold, a value at which the wireless device easily decodes a frame addressed to its own BSS and easily ignores a frame addressed to another BSS, on the basis of the reception environment.

Furthermore, according to a third aspect, there is desirably provided a CCA threshold determination method for determining a CCA threshold used in a wireless communication system including a plurality of wireless devices configured by base stations or terminals, the method comprising: by at least one of the wireless devices,
performing carrier sensing to determine presence or absence of a frame having a reception power value equal to or greater than a transmission CCA threshold when a transmission request occurs;
transmitting a frame in a case where the absence of the frame having the reception power value equal to or greater than the transmission CCA threshold is confirmed as a result of the carrier sensing;
detecting an environment for receiving a frame regardless of execution of the carrier sensing;
setting a reception CCA threshold on the basis of the reception environment; and
ignoring a frame having a reception power value less than the reception CCA threshold and decoding the frame having a reception power value equal to or greater than the reception CCA threshold,
in which the reception CCA threshold is set to a value at which a frame addressed to its own BSS is easily decoded and a frame addressed to another BSS is easily ignored, on the basis of the reception environment.

Furthermore, according to a fourth aspect, there is desirably provided a CCA threshold determination program for determining a CCA threshold used in a wireless communication system including a plurality of wireless devices configured by base stations or terminals, the program being computer-readable, and causing each of the wireless devices to execute:
processing of performing carrier sensing to determine presence or absence of a frame having a reception power value equal to or greater than a transmission CCA threshold when a transmission request occurs;
processing of transmitting a frame in a case where the absence of the frame having the reception power value equal to or greater than the transmission CCA threshold is confirmed as a result of the carrier sensing;
reception environment detection processing of detecting an environment for receiving a frame regardless of execution of the carrier sensing;
threshold setting processing of setting a reception CCA threshold on the basis of the reception environment; and
processing of ignoring a frame having a reception power value less than the reception CCA threshold and decoding the frame having a reception power value equal to or greater than the reception CCA threshold,
in which the threshold setting processing includes processing of setting, as the reception CCA threshold, a value at which a frame addressed to its own BSS is easily decoded and a frame addressed to another BSS is easily ignored, on the basis of the reception environment.

### Advantageous Effects of Invention

According to the first to fourth aspects, it is possible to provide a high communication quality in an environment where wireless devices are dense by separately setting a transmission CCA threshold, used for carrier sensing at the time of transmission, and a reception CCA threshold, used for selecting a reception frame.

### BRIEF DESCRIPTION OF DRAWINGS

FIG. 1 is a diagram illustrating an overall configuration of a CCA threshold determination system according to a first embodiment of the present disclosure;

FIG. 2 is a diagram for describing an operation of changing a transmission CCA threshold for determining whether or not an AP 1 illustrated in FIG. 1 can perform transmission;

FIG. 3 is a diagram for describing a problem that occurs in a dense environment illustrated in FIG. 1;

FIG. 4 is a block diagram for describing a configuration of an AP and a configuration of an STA in the first embodiment of the present disclosure;

FIG. 5 is a block diagram for describing an operation of a MAC unit when an AP illustrated in FIG. 4 functions as a transmission station;

FIG. 6 is a block diagram for describing an operation of a MAC unit when an AP illustrated in FIG. 4 functions as a reception station;

FIG. 7 is a block diagram for describing an operation of a PHY unit when an AP illustrated in FIG. 4 functions as a transmission station;

FIG. 8 is a block diagram for describing an operation of a PHY unit when an AP illustrated in FIG. 4 functions as a reception station;

FIG. 9 is a flowchart for describing a flow of an operation when an AP in the first embodiment of the present disclosure functions as a transmission station;

FIG. 10 is a flowchart for describing a flow of processing executed by an AP in the first embodiment of the present disclosure to set a reception CCA threshold;

FIG. 11 is a diagram for describing a method for setting a reception CCA threshold in a fourth embodiment of the present disclosure; and

FIG. 12 is a diagram illustrating a state in which functions of an AP and an STA in the first embodiment of the present disclosure are swapped.

### DESCRIPTION OF EMBODIMENTS

### First Embodiment

### [Basic Configuration of First Embodiment]

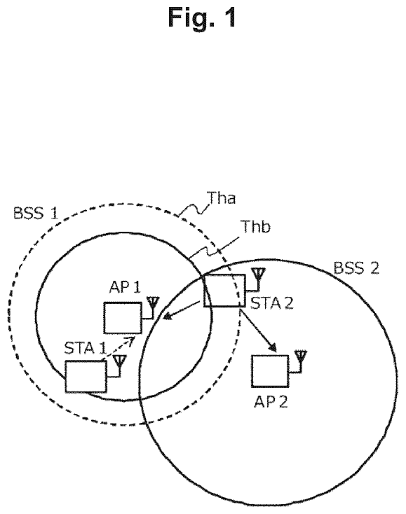

FIG. 1 illustrates an overall configuration of a CCA threshold determination system according to a first embodiment of the present disclosure. More specifically, FIG. 1 illustrates a state in which a plurality of base stations (APs) and a plurality of terminals (STA) are included in two basic service sets (BSSs). Here, it is assumed that an AP 1 and an STA 1 constitute a BSS 1, and an AP 2 and an STA 2 constitute a BSS 2. That is, for the AP 1, the STA 1 is a subordinate terminal belonging to its own BSS, and the STA 2 is a non-subordinate terminal belonging to another BSS.

In the example illustrated in FIG. 1, a CCA threshold determination system is configured for each of the BSS 1 and the BSS 2. Specifically, in the example illustrated in FIG. 1, the AP 1 belonging to the BSS 1 constitutes the CCA threshold determination system together with the STA 1 and the STA 2 located at positions where wireless frames can be exchanged. Furthermore, the AP 1 belonging to the BSS 2 constitutes the CCA threshold determination system together with the STA 2 located at a position where wireless frames can be exchanged.

Each of the AP 1 and the AP 2 performs carrier sensing when a data frame transmission request occurs. Both the AP and the STA in the present embodiment include information regarding a BSS color indicating the belonging BSS in a PHY preamble of the transmission frame. Therefore, when the AP 1 detects a frame emitted by the STA 1 through the execution of the carrier sensing, the AP 1 identifies the frame as a frame addressed to its own BSS. Similarly, the AP 1 identifies a frame emitted by the STA 2 as a frame addressed to another BSS.

In FIG. 1, a circle with a broken line centered on the AP 1 schematically indicates a detection area in a case where the transmission CCA threshold of the AP 1 is a default value Tha. Furthermore, a solid-line circle centered on the AP 1 indicates a detection area in a case where the transmission CCA threshold is an increase value Thb.

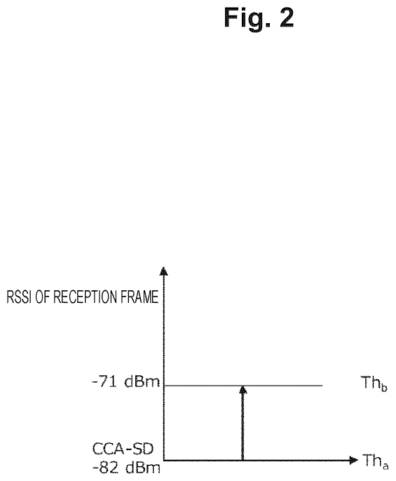

FIG. 2 illustrates a relationship between the default value Tha and the increase value Thb. As illustrated in FIG. 2, the increase value Thb is a value larger than the default value Tha. As the CCA threshold for determining the presence or absence of a carrier is smaller, the sensitivity of the AP 1 increases, and a weak radio wave is detected. Therefore, as illustrated in FIG. 1, the detection area (broken line) based on the default value Tha becomes larger than the detection area (solid line) based on the increase value Thb.

In the present embodiment, the AP 1 sets the transmission CCA threshold to the default value Tha when detecting a frame addressed to its own BSS by performing carrier sensing. As a result, in a case where the frame addressed to its own BSS is transmitted, it is easy to determine that “there is a carrier”, and data collision due to transmission from the AP 1 hardly occurs. On the other hand, in a case where the frame addressed to another BSS is detected by performing carrier sensing, the AP 1 changes the transmission CCA threshold to the increase value Thb. In the example of FIG. 1, as a result, the transmission from the STA 2 is excluded from the detection target, and the transmission is permitted to the AP 1. As described above, in the present embodiment, by appropriately changing and using the transmission CCA threshold, a function of avoiding a collision in its own BSS and a function of avoiding a loss of a transmission opportunity due to communication of another BSS are given to the AP 1.

### [Problems to be Solved by First Embodiment]

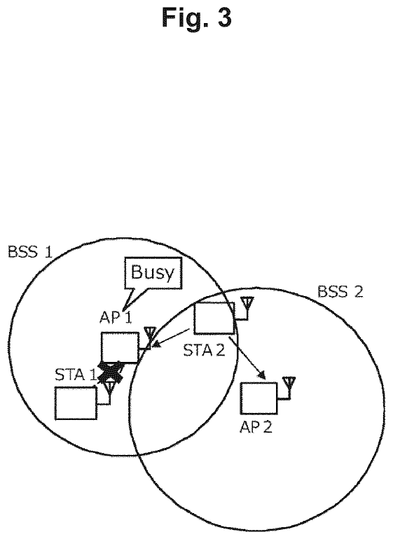

FIG. 3 is a diagram for describing a problem to be further solved in increasing a communication quality using the above-described functions. In a period during which the AP 1 itself does not transmit data, when a frame with an intensity satisfying the CCA threshold is received, the AP 1 starts decoding the frame.

FIGS. 1 and 3 illustrate a state in which only one STA 1 belongs to the BSS 1 for convenience, but a large number of STAs may belong thereto at the same time. In addition, the STA 2 belonging to the BSS 2, which is another BSS, may be present at a position where the distance from the AP 1 is equivalent to that of the STA 1. Therefore, frames emitted by a large number of the STAs may frequently arrive at the AP 1. In this case, even in a case where the STA 1 transmits a high-priority frame, when the AP 1 is busy decoding the signal from another STA, the high-priority frame may not be received by the AP 1.

Thus, in the present embodiment, the reception CCA threshold is set in the AP 1 separately from the transmission CCA threshold for avoiding collision of own transmission with other communication. Then, the reception CCA threshold is set to a value at which a specific frame is likely to be preferentially received by the AP 1.

### [Detailed Configuration of First Embodiment]

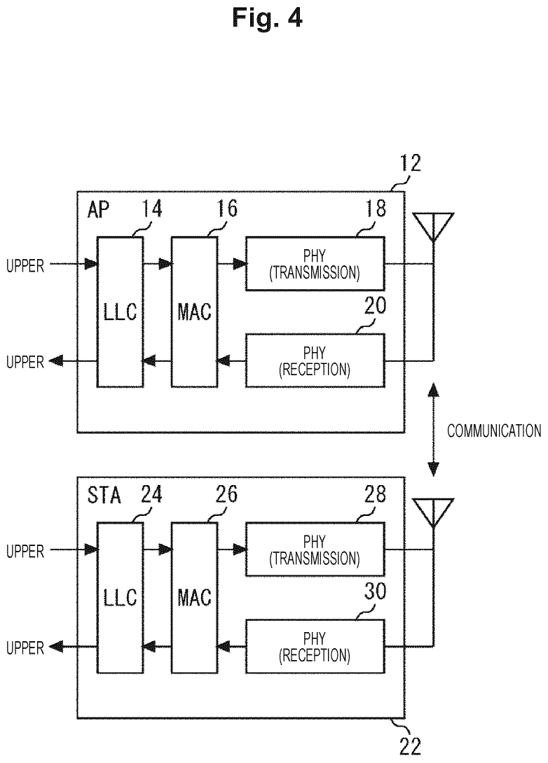

FIG. 4 is a block diagram for describing a configuration of an AP 12 and a configuration of an STA 22 in the first embodiment of the present disclosure. It is assumed that the AP 1 and AP 2, and the STA 1 and STA 2, which are illustrated in FIG. 1, have a configuration to be described below. Specifically, this configuration is made by combining dedicated hardware with a CPU, a memory device, and various input/output interfaces. Furthermore, the memory device stores a program to be executed by the CPU. The various functions to be described later are implemented by the CPU performing processing in accordance with the above-described program.

As illustrated in FIG. 4, the AP 12 transmits data input from an upper layer as a wireless signal through a logical link control (LLC) unit 14, a medium access control (MAC) unit 16, and a physical (PHY) transmission unit 18. Furthermore, the AP 12 provides the received wireless signal to the upper layer through a PHY reception unit 20, a MAC unit 16, and an LLC unit 14. Similarly, the STA 22 also transmits and receives data through an LLC unit 24, a MAC unit 26, a PHY transmission unit 28, and a PHY reception unit 30.

The LLC units 14 and 24 have a role as an interface with an upper layer. In a case where data is input from the upper layer, a header such as DSAP or SSAP is added thereto. Furthermore, in a case where the data is input from the MAC units 16 and 26, the LLC units 14 and 24 delete the header and provide the data to the upper layer.

When packets are input from the LLC units 14 and 24, the MAC units 16 and 26 assign MAC headers including a transmission destination address, a transmission source address, a sequence number, a TID, and an error detection code to the packets. Furthermore, prior to data transmission, whether or not transmission is possible is determined by a CSMA/CA method on the basis of the power of signals received by the PHY reception units 20 and 30. At the time of determining whether or not transmission can be performed, a threshold may be controlled on the basis of a BSS Color that is belonging information of the received BSS or a QoS Color that is priority information of a frame. Furthermore, setting of a frame counter value for a subordinate terminal or the like and evaluation of fairness are performed. Moreover, in a case where a high-priority QoS frame is transmitted, count processing on the number of times of transmission and the total traffic amount of the frame is performed. When packets are input from the PHY reception units 20 and 30, the MAC units 16 and 26 demodulate the MAC headers included in the packets. Then, in a case where the packets are data addressed to their own station, processing of outputting the packets toward the LLC units 14 and 24 is performed.

When receiving an input of frames from the MAC units 16 and 26, the PHY transmission units 18 and 28 add a PHY header, a preamble, and the like to the frames, and then transmit the frames as a wireless signal. The preamble includes a BSS color and a QoS color. In particular, the latter may be assigned with reference to TID information or the like of the MAC header.

When receiving the wireless signal, the PHY reception units 20 and 30 demodulate the PHY header, the preamble, and the like included in the signal. At this time, simultaneously with the demodulation, the BSS color and the QoS color described in the preamble may be identified and input to the MAC units 16 and 26 together with the payload.

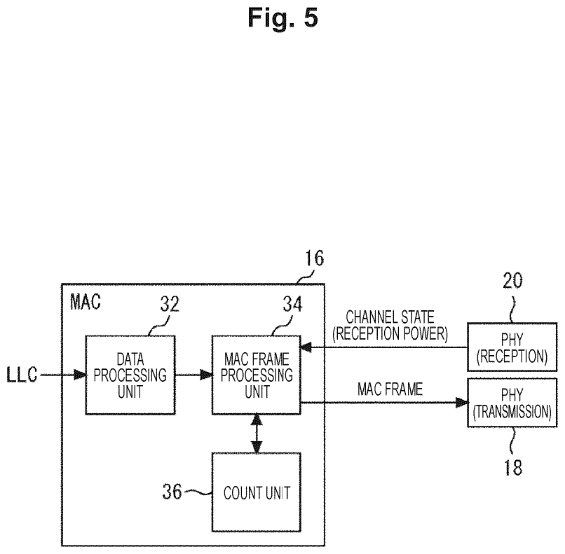

FIG. 5 is a block diagram for describing the operation of the MAC unit 16 when the AP 12 functions as the transmission station. Here, in a data processing unit 32, the MAC header is attached to the data input from the LLC unit 14. In the MAC header, information such as a transmission destination address and a TID indicating priority of data is written. The data processed by the data processing unit 32 is input to a MAC frame processing unit 34.

The MAC frame processing unit 34 determines whether or not transmission can be performed by the CSMA/CA method on the basis of the reception power input from the PHY reception unit 20. Specifically, carrier sensing is performed for a randomly set time, and it is determined that transmission is possible when the idle state of the channel can be confirmed. When this determination is made, the MAC frame processing unit 34 inputs the transmission data to the PHY transmission unit 18.

The transmission CCA threshold used for carrier sensing may be determined according to a combination of the BSS color and the QoS color. Furthermore, the transmission information of the QoS frame and the selection information of the CCA threshold, which are used in the MAC frame processing unit 34, are input to a count unit 36. The count unit 36 counts the number of times of transmission of the QoS frame and the total extension of the QoS frame on the basis of the information of the QoS frame input in this manner.

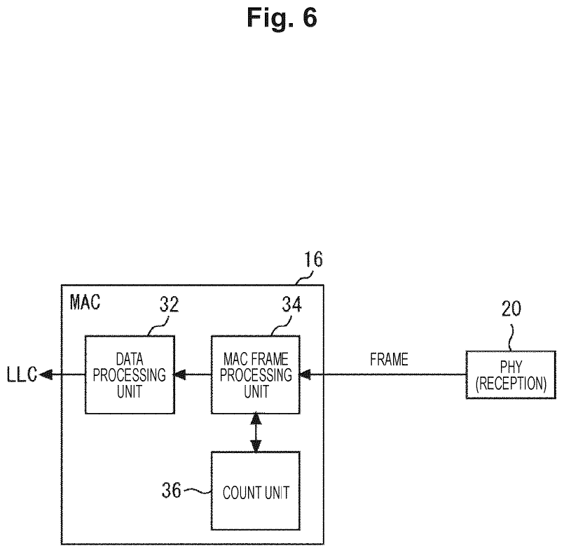

FIG. 6 is a block diagram for describing the operation of the MAC unit 16 when the AP 12 functions as the reception station. A frame to be addressed to its own BSS, which is detected by the PHY reception unit 20, is input to the MAC frame processing unit 34.

The data processing unit 32 extracts data with reference to the MAC header of the input frame and inputs the data to the LLC unit 14.

The transmission information of the QoS frame, information regarding a reception power value, selection information of a CCA threshold, and the like, which are used in the MAC frame processing unit 34, are input to the count unit 36, and used for counting of the QoS frame.

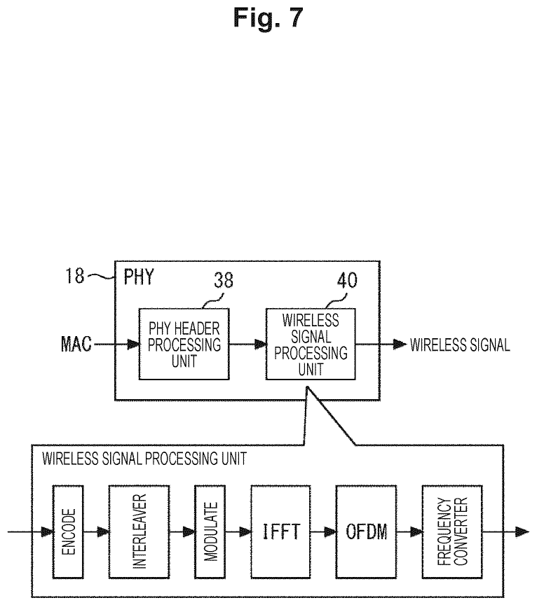

FIG. 7 is a block diagram for describing the operation of the PHY unit 18 when the AP 12 illustrated in FIG. 4 functions as the transmission station. Here, in particular, the operation of the PHY unit 18 when the AP 12 transmits a frame to which the QoS color indicating a high priority is added together with the BSS color will be described.

The PHY unit 18 includes a PHY header processing unit 38. The PHY header processing unit 38 assigns the PHY header to the data input from the MAC unit 16. The PHY header can include information such as the BSS color and the QoS color. The values of the BSS color and QoS color are determined on the basis of the BSS information and the TID information included in the MAC header.

The data to which the PHY header is added in the PHY header processing unit 38 is input to a wireless signal processing unit 40. The wireless signal processing unit 40 performs the processing illustrated in the lower portion of FIG. 7 on the input frame to generate a wireless signal. The PHY unit 18 transmits the wireless signal generated in this manner.

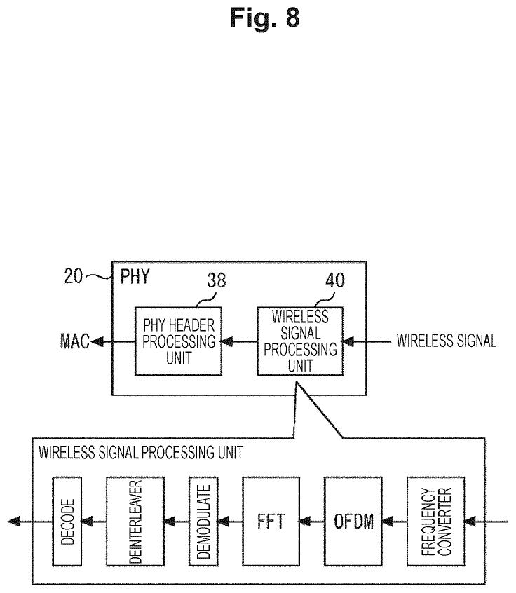

FIG. 8 is a block diagram for describing the operation of the PHY unit 20 when the AP 12 illustrated in FIG. 4 functions as the reception station. Here, in particular, the operation of the PHY unit 20 when the AP 12 receives a frame to which the QoS color is added together with the BSS color will be described.

The PHY unit 20 receives the wireless signal by performing the carrier sensing and also receives the wireless signal when the carrier sensing is not performed. In any case, when detecting the wireless signal, the wireless signal processing unit 40 decodes the radio signal by the processing illustrated in the lower portion of FIG. 8. The frame obtained as the result of this is output to the PHY header processing unit 38.

At this time, the PHY header processing unit 38 identifies information included in the PHY header of the input frame. In particular, the operation will be performed below on the basis of information regarding the BSS color and QoS color included in the PHY header.

### [At Time of Frame Reception (at Time of Non-Carrier Sensing)]

In a case where the BSS colors match, that is, in a case where the reception frame is addressed to its own BSS, the demodulation processing is continuously performed. On the other hand, in a case where the BSS colors do not match, the demodulation operation stops. However, in either case, the MAC unit 16 is notified of the information regarding the BSS color and QoS color. Furthermore, in the present embodiment, as described later, the reception CCA threshold is determined on the basis of a combination of the BSS color and the QoS color. At the time of frame reception, the MAC unit 16 is also notified of the value.

### [At Time of Carrier Sensing (at Time of Frame Transmission)]

In the present embodiment, the transmission CCA threshold used at the time of carrier sensing is determined on the basis of the BSS color. In a case where a wireless signal is received by performing carrier sensing, the MAC unit 16 is also notified of the determined transmission CCA threshold.

### [Operation of First Embodiment]

### (Carrier Sensing)

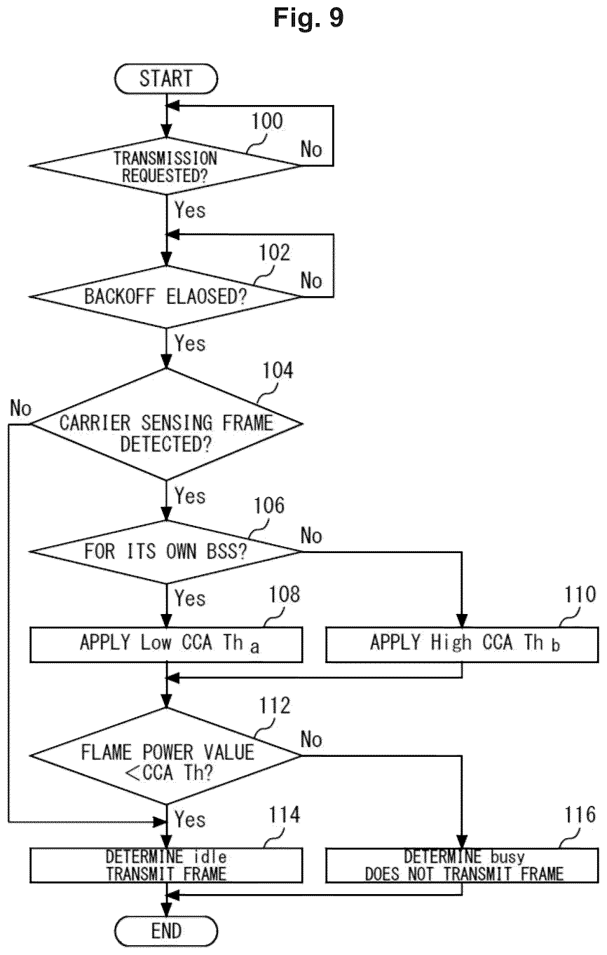

FIG. 9 is a flowchart for describing a flow of the operation when the AP 12 in the present embodiment functions as the transmission station. In the routine illustrated in FIG. 9, first, it is determined whether or not the transmission request occurs in the AP 12 (step 100).

When the generation of the transmission request is recognized, next, it is determined whether or not a randomly set backoff has elapsed (step 102). The backoff is a waiting time before the start of carrier sensing.

When it is determined that backoff has elapsed, the carrier sensing is started. Specifically, first, it is determined whether or not any carrier sensing frame emitted by another wireless device is detected (step 104).

When no carrier sensing frame is detected, it can be determined that a channel is clear at that time. In this case, the processing of step 114 to be described later is immediately executed. On the other hand, in a case where a carrier sensing frame is detected, it is determined whether or not the destination of the frame belongs to its own BSS on the basis of the BSS color included in the header information (step 106).

In a case where it is determined that the destination belongs to its own BSS, the default value Tha is applied as the transmission CCA threshold used for PHY preamble detection (step 108). As described above, the default value Tha is a small value for setting the sensitivity of carrier sensing to be high.

On the other hand, in a case where it is determined that the destination does not belong to its own BSS, the increase value Thb is applied as the transmission CCA threshold used (step 110). The increase value Thb is a value larger than the default value Tha. Therefore, in a case where the increase value Thb is applied, the sensitivity of carrier sensing is lower than that in a case where the default value Tha is set.

When the above-described processing ends, next, it is determined whether or not the reception power value of the detected frame is smaller than the transmission CCA threshold (step 112).

As a result, in a case where it is determined that the frame power value is smaller than the transmission CCA threshold, it can be determined that the channel is clear. In this case, idle determination is made, and frame transmission by the AP 12 is permitted (step 114).

On the other hand, in step 112, in a case where it is determined that the frame power is not smaller than the transmission CCA threshold, it can be determined that the channel is not clear. In this case, a busy determination is made, and the AP 12 does not perform the frame transmission at the current time point (step 116).

According to the above-described processing, the AP 12 makes the busy determination with high sensitivity for the frame addressed to its own BSS. Therefore, communication in its own BSS can be effectively protected. Furthermore, the AP 12 makes the busy determination with low sensitivity for the frame addressed to another BSS. Therefore, the AP 12 can obtain a transmission opportunity with an appropriate frequency without excessively reacting to communication of another BSS even in an environment where the wireless devices are dense.

(frame Reception)

In the present embodiment, the AP 12 differentiates and sets the CCA thresholds determined by the SR function defined in the IEEE802.11ax standard between the transmission side and the reception side. In particular, in a case where the reception CCA threshold should be determined, the AP 12 can determine the reception CCA threshold on the basis of a reception power value from a specific terminal among subordinate terminals present in its own BSS or a reception power value from another BSS terminal present in another BSS. The specific terminal will be described in detail later. Note that the upper limit of the reception CCA threshold may be set in advance for the AP, and the CCA threshold may not be increased in a range exceeding the upper limit.

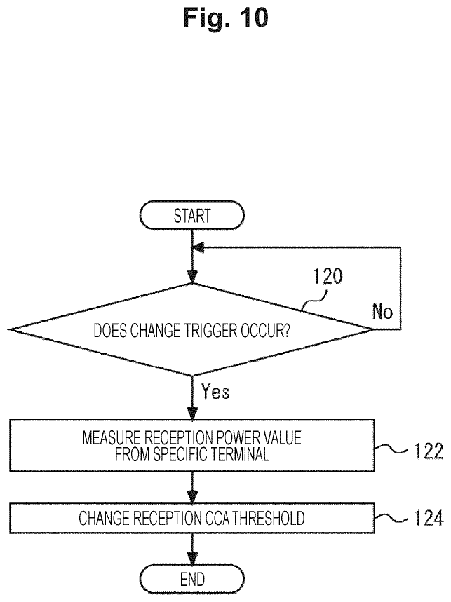

FIG. 10 is a flowchart for describing a flow of the processing executed by the AP 12 to set the reception CCA threshold in the present embodiment. As described above, the AP 12 sets the transmission CCA threshold by the routine illustrated in FIG. 9. The transmission CCA threshold is used only when the AP 12 performs carrier sensing. During a period in which the carrier sensing is not performed, the AP 12 determines whether or not to start decoding the reception frame by using the reception CCA threshold set by the routine illustrated in FIG. 10.

In the routine illustrated in FIG. 10, first, it is determined whether or not a trigger to change the reception CCA threshold occurs (step 120). In the present embodiment, as described above, the reception CCA threshold is set on the basis of the reception power value from the specific terminal present around the base station AP 12. Therefore, in a case where the position of the specific terminal or the reception power value from the specific terminal greatly changes, it is necessary to newly set the reception CCA threshold again. Specifically, in this step 120, it is determined whether or not a change exceeding a predetermined determination value occurs in the position of the specific terminal or the reception power value from the specific terminal.

When the above-described change is recognized, next, the reception power value from the specific terminal is measured (step 122). The specific terminal is set as any one of the following STAs.
(1) One of QoS terminals under the control of the AP. If there is a significant variation in the received power values among QoS terminals, the terminal with the smallest received power value among the QoS terminals may be selected.
(2) An STA present at a farthest position among STAs under the control of the AP. Note that the STA notifies the AP of its own position information.
(3) An STA that transmits the QoS frames the most during a certain period among STAs under the control of the AP.
(4) An STA that has the longest transmission air time of the QoS frame among STAs under the control of the AP.

Then, a reception CCA threshold is determined on the basis of a reception environment of the frame of the AP (step 124). Here, the reception power value from the specific terminal is set as a reception environment. That is, in step 124, a reception power value A from the specific terminal is set as the reception CCA threshold such that the reception power value A becomes the minimum value satisfying a decoding condition. Note that the reception CCA threshold is not limited to the reception power value A itself, and may be a value obtained by adding or subtracting a margin value a to or from the reception power value A.

In a case where the specific terminal is set according to (1) above, the reception CCA threshold is set to a value that decodes the frame from the subordinate QoS terminal with high probability and ignores a frame lower in level than the frame. In this case, the probability that the AP 12 becomes busy by decoding the frame with low priority decreases. As a result, the probability that the AP 12 receives the QoS frame from its own BSS can be increased.

In a case where the specific terminal is set according to (2) above, the reception CCA threshold is set to a value that decodes the frames from all the subordinate STAs with high probability and ignores a frame lower in level than the frames. In this case, the probability that the AP 12 starts decoding the frame from another BSS terminal located at a position farther than the specific terminal decreases. As a result, the probability that the AP 12 receives the frame from the STA in its own BSS can be increased.

In a case where the specific terminal is set according to (3) above, the reception CCA threshold is set to a value that decodes the frame from the QoS terminal that emits the QoS frame most frequently with high probability and ignores a frame lower in level than the frame. In this case, the probability that the AP 12 receives the frame from the QoS terminal can be increased, and the success probability of the QoS frame in its own BSS can be increased.

In a case where the specific terminal is set according to (4) above, the reception CCA threshold is set to a value that decodes the frame from the QoS terminal having the longest transmission air time with high probability and ignores a frame lower in level than the frame. In this case, the probability that the AP 12 receives the frame from the QoS terminal can be increased, and the success probability of the QoS frame in its own BSS can be increased.

Note that, in the first embodiment described above, the reception CCA threshold is changed in a case where the occurrence of the change trigger is recognized, but the present disclosure is not limited thereto. For example, the position of the specific terminal described above may be continuously detected, and the reception CCA threshold may be changed following the position of the specific terminal. The same applies to other embodiments to be described below.

### Second Embodiment

Next, a second embodiment of the present disclosure will be described. A CCA threshold determination system according to the present embodiment is similar to the CCA threshold determination system according to the first embodiment except that the STA serving as the specific terminal is different and that the value of the reception CCA threshold set on the basis of the specific terminal is different. Hereinafter, the features of the present embodiment will be described.

In the present embodiment, in step 122 illustrated in FIG. 10, a specific STA in another BSS is specified as the specific terminal, rather than the STA in its own BSS. Specifically, in the present embodiment, any one of the following STAs is set as the specific terminal.
(1) An STA present at the closest position among STAs in another BSS present around the AP 12. Note that the STA notifies the AP of its own position information.
(2) An STA that transmits the QoS frames or normal frames the most during a certain period among STAs in another BSS present around the AP 12.
(3) An STA that has the longest transmission air time of the QoS frame or the normal frame among STAs in another BSS present around the AP 12.

In the present embodiment, in step 124 illustrated in FIG. 10, a value “B+α” obtained by adding a margin value a to a reception power value B from the specific terminal in another BSS is set as the reception CCA threshold. That is, the reception CCA threshold is determined such that the reception power value B from the specific terminal becomes the maximum value that does not satisfy the decoding condition.

In a case where the specific terminal is set according to (1) above, the reception CCA threshold is set to a value that ignores the frame from another BSS terminal which is the closest with high probability and decodes a frame higher in level than the frame. In this case, the probability that the AP 12 becomes busy by decoding the frame from another BSS terminal decreases. As a result, the probability that the AP 12 receives the frame from its own BSS can be increased.

In a case where the specific terminal is set according to (2) above, the reception CCA threshold is set to a value that ignores the frame from another BSS terminal that emits the frame the most frequently with high probability and decodes a frame higher in level than the frame. In this case, the probability that the AP 12 becomes busy due to the frame from another BSS terminal decreases. As a result, the probability that the AP 12 receives the frame from its own BSS can be increased.

In a case where the specific terminal is set according to (3) above, the reception CCA threshold is set to a value that ignores the frame from another BSS terminal having the longest transmission air time with high probability and decodes a frame higher in level than the frame. In this case, similarly to the case of (2) above, the probability that the AP 12 receives the frame from its own BSS can be increased.

### Third Embodiment

A third embodiment of the present disclosure will be described. A CCA threshold determination system of the present embodiment is similar to the CCA threshold determination system according to the first embodiment, except that the specific terminal is set in both its own BSS and another BSS, and the reception CCA threshold is determined on the basis of comparison between the reception power values of two specific terminals. Hereinafter, the features of the present embodiment will be described.

In the present embodiment, in step 122 illustrated in FIG. 10, one of the STAs in its own BSS is specified as a first specific terminal, and one of other BSS terminals is specified as a second specific terminal. Furthermore, in step 122, both the reception power value A of the first specific terminal and the reception power value B of the second specific terminal are measured. Note that the first specific terminal may be determined by any of the methods (1) to (4) described in the first embodiment. Furthermore, the second specific terminal may be determined by any of the methods (1) to (3) described in the second embodiment.

In the present embodiment, in step 124 illustrated in FIG. 10, the reception CCA threshold is set as follows on the basis of the comparison between the reception power value A of the first specific terminal and the reception power value B of the second specific terminal.
(1) In a case of A≤B: Reception CCA threshold=A
(2) In a case of A>B: Reception CCA threshold=B+α

In any of (1) and (2) above, the reception CCA threshold is set to a value that ignores the frame from the specific terminal in another BSS and decodes the frame higher in level than the frame. In this case, the probability that the AP 12 becomes busy by decoding the frame from another BSS terminal decreases. As a result, the probability that the AP 12 receives the frame from its own BSS can be increased.

### Fourth Embodiment

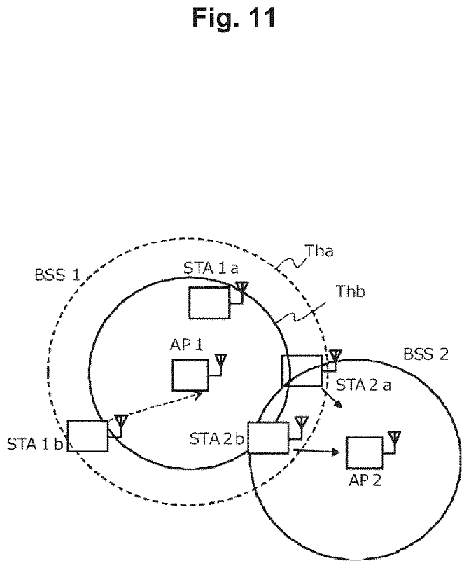

Next, a fourth embodiment of the present disclosure will be described with reference to FIG. 11. A CCA threshold determination system of the present embodiment is similar to the CCA threshold determination system of the first embodiment except that the reception CCA threshold is determined by a method to be described below.

FIG. 11 is a diagram for describing a method in which the AP 12 sets the reception CCA threshold in the present embodiment. In FIG. 11, a circle with a broken line centered on the AP 1 indicates a detection area in a case where a search purpose CCA threshold is set as a default value Tha. Furthermore, a solid-line circle centered on the AP 1 indicates a detection area in a case where an increase value Thb larger than the default value Tha is set as the search purpose CCA threshold.

In the example illustrated in FIG. 11, in a case where the AP 1 sets the default value Tha as the search purpose CCA threshold, two own BSS terminals (STA 1a and STA 1b) and two other BSS terminals (STA 2a and STA 2b) are included in the detection area. Then, when the search purpose CCA threshold is changed from the default value Tha to the increase value Thb, one own BSS (STA 1b) and two other BSS terminals (STA 2a and STA 2b) are outside the detection area, and only STA 1a that is the own BSS remains as the detection target.

As described above, when the CCA threshold of the AP 1 is increased or decreased, the number of its own BSS terminals and the number of other BSS terminals, which are located in the detection area, are individually changed according to the change of the CCA threshold. Then, in an environment where a large number of its own BSS terminals and a large number of other BSS terminals are densely present, if the CCA threshold continues to be changed so that more other BSS terminals move out of the detection area than its own BSS terminals, ultimately, the proportion of its own BSS terminals remaining in the detection area can be maximized.

In order to increase the probability that the AP 1 receives a frame in its own BSS without being disturbed by frames from other BSS terminals, it is desirable that the ratio of its own BSS terminals included in the detection area of the AP 1 is higher. Therefore, the AP 12 of the present embodiment determines the reception CCA threshold by the following method in order to meet the above-described request.
(S1) The search purpose CCA threshold of the AP 12 is set to an initial value (for example, Tha).
(S2) The number of its own BSS terminals and the number of other BSS terminals from which the AP 12 can receive a frame are measured.
(S3) The search purpose CCA threshold is increased by ΔTh dBm to detect the number N1 of its own BSS terminals that cannot be detected and the number N2 of other BSS terminals that cannot be detected.

(S4) The (S2) and (S3) above are repeated while the decreasing number N1 of its own BSS terminals is smaller than the decreasing number N2 of other BSS terminals.

(S5) The search purpose CCA threshold (Tha+n*ΔTh) at the limit point where N1<N2 holds is determined as the reception CCA threshold.

According to the above-described method, the AP 12 can set the reception CCA threshold such that the ratio of its own BSS terminals in the detection area is maximized. Therefore, according to the present embodiment, similarly to the first to third embodiments, it is possible to cause the AP 12 to preferentially receive the frame from its own BSS terminal with the high probability.

Note that, in the above-described example, the search purpose CCA threshold for the limit point satisfying N1<N2 is determined as the reception CCA threshold, but the method for maximizing the ratio of terminals in its own BSS is not limited thereto. For example, the search purpose CCA threshold may be changed from the upper limit to the lower limit, which are settable, and the search purpose CCA threshold that maximizes the ratio of terminals in its own BSS may be found on the basis of the result. Alternatively, the ratio of terminals in the own BSS may be determined in advance, and the maximum or minimum search purpose CCA threshold satisfying the ratio may be set as the reception CCA threshold.

### [Modification Examples of First to Fourth Embodiments]

In the first to fourth embodiments described above, the reception CCA threshold is always set separately from the transmission CCA threshold without considering the communication environment. However, the present disclosure is not limited thereto. For example, the operations in the first to fourth embodiments may be performed only under a situation where communication is congested on the basis of the total traffic amount generated under the control of the AP 12 or the traffic ratio of the QoS frames. That is, the operation of the first to fourth embodiments may not be performed in a case where the total traffic amount or the like is equal to or less than a certain threshold, and the operations in the first to fourth embodiments may be performed only in a case where the total traffic amount or the like exceeds a predetermined threshold.

Furthermore, in any of the first to fourth embodiments described above, a margin may be added to the reception CCA threshold according to the variation in the reception power from the STA as a reference. In this case, the maximum value of the variation in the reception power may be used as the margin, or the average value of the variations may be added as the margin. Moreover, a range in which the reception CCA threshold can be acquired may be specified in advance.

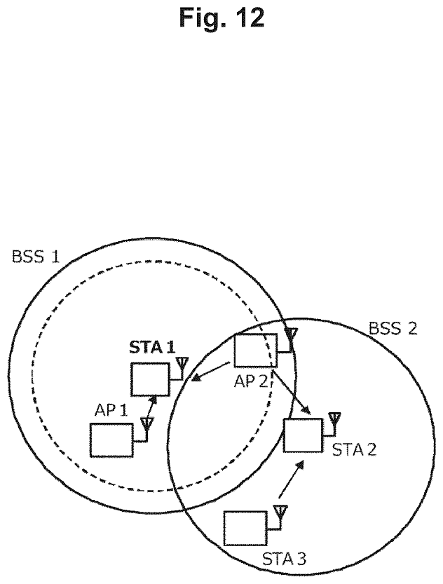

Furthermore, the operation described above may be performed by swapping the function of the AP and the function of the STA. As illustrated in FIG. 12, the reference power value for the STA 1 to determine the reception CCA threshold may be determined by the methods of the first to fourth embodiments or the modification examples thereof on the basis of the reception power values from the AP 1 and AP 2 with which the STA 1 is associated, the reception power value from the unassociated AP 3, the QoS frame ratio in a frame transmitted by each of the APs 1 to 3, or the like.

Furthermore, in the first to fourth embodiments described above, the transmission CCA threshold is set in consideration of only the BSS color of the carrier sensing frame. However, the present disclosure is not limited thereto. For example, in a case where the QoS color is included in the carrier sensing frame, the transmission CCA threshold may be lowered in order to protect the QoS frame. Furthermore, in a case where the frame to be transmitted by the STA 1 is a QoS frame, the transmission CCA threshold may be changed to a large value in order to secure a transmission opportunity.

Furthermore, in the first to fourth embodiments described above, the transmission CCA threshold and the reception CCA threshold are individually set, but the present disclosure is not limited thereto. The reception CCA threshold may be determined and this may be applied to the transmission CCA threshold.

### REFERENCE SIGNS LIST

AP1, AP2, AP12 Base station
STA1, STA2, STA22, STA1a, STA1b, STA2a, STA2b Terminal
Tha Default value of CCA threshold
Thb Increase value of CCA threshold
BSS Basic Service Set

1. A CCA threshold determination system that determines a CCA threshold used in a wireless communication system including a plurality of wireless communicators configured by base stations or terminals,
wherein at least one of the wireless communicators is configured to perform:
carrier sensing to determine presence or absence of a frame having a reception power value equal to or greater than a transmission CCA threshold when a transmission request occurs;
transmission of a frame in a case where the absence of the frame having the reception power value equal to or greater than the transmission CCA threshold is confirmed as a result of the carrier sensing;
detection of an environment for receiving a frame regardless of execution of the carrier sensing;
setting of a reception CCA threshold on a basis of the reception environment; and
ignoring of a frame having a reception power value less than the reception CCA threshold and decoding the frame having a reception power value equal to or greater than the reception CCA threshold, and
the setting of the reception CCA threshold includes setting of a value at which a frame addressed to its own BSS is easily decoded and a frame addressed to another BSS is easily ignored, on a basis of the reception environment.

2. The CCA threshold determination system according to claim 1,
wherein the detection of the environment includes detection of a reception power value A from a specific terminal in its own BSS as the reception environment, and
the setting of the reception CCA threshold is performed such that a frame having a reception power value equal to or greater than the reception power value A is decoded.

3. The CCA threshold determination system according to claim 1,
wherein the detection of the environment includes detection of a reception power value B from a specific terminal in another BSS as the reception environment, and
the setting of the reception CCA threshold is performed such that a frame having a reception power value equal to or less than the reception power value B is ignored.

4. The CCA threshold determination system according to claim 1,
wherein the detection of the environment includes
detection of a reception power value A from a specific terminal in its own BSS as the reception environment, and
detection of a reception power value B from a specific terminal in another BSS as the reception environment,
the setting of the reception CCA threshold includes
comparing the reception power value A with the reception power value B,
setting the reception CCA threshold such that a frame having a reception power value equal to or greater than the reception power value A is decoded in a case where the reception power value A is smaller than the reception power value B, and
setting the reception CCA threshold such that a frame having a reception power value equal to or less than the reception power value B is ignored in a case where the reception power value B is smaller than the reception power value A.

5. The CCA threshold determination system according to claim 1,
wherein the detection of the environment includes detection of the number of terminals in its own BSS and the number of terminals in another BSS, which are generating a reception power value equal to or greater than a search purpose CCA threshold, and
the of the reception CCA threshold includes
changing the search purpose CCA threshold so as to increase a ratio of terminals in the its own BSS, which are generating a reception power value equal to or greater than the search purpose CCA threshold, and
setting the search purpose CCA threshold that maximizes the ratio as the reception CCA threshold.

6. A CCA threshold determination device that determines a CCA threshold used in a wireless communicator configured by a base station or a terminal, the CCA threshold determination device being configured to perform:
carrier sensing to determine presence or absence of a frame that reaches the wireless communicator using a reception power value equal to or greater than a transmission CCA threshold when a transmission request occurs in the wireless communicator;
permitting the wireless communicator to transmit a frame in a case where the absence of the frame having the reception power value equal to or greater than the transmission CCA threshold is confirmed as a result of the carrier sensing;
detection of an environment where the wireless communicator receives a frame regardless of execution of the carrier sensing;
setting of a reception CCA threshold on a basis of the reception environment; and
causing the wireless communicator to ignore a frame having a reception power value less than the reception CCA threshold and decode the frame having a reception power value equal to or greater than the reception CCA threshold,
wherein the setting of the reception CCA threshold includes setting of a value at which the wireless communicator easily decodes a frame addressed to its own BSS and easily ignores a frame addressed to another BSS, on a basis of the reception environment.

7. A CCA threshold determination method for determining a CCA threshold used in a wireless communication system including a plurality of wireless communicators configured by base stations or terminals, the method comprising: by at least one of the wireless communicators,
performing carrier sensing to determine presence or absence of a frame having a reception power value equal to or greater than a transmission CCA threshold when a transmission request occurs;
transmitting a frame in a case where the absence of the frame having the reception power value equal to or greater than the transmission CCA threshold is confirmed as a result of the carrier sensing;
detecting an environment for receiving a frame regardless of execution of the carrier sensing;
setting a reception CCA threshold on a basis of the reception environment; and
ignoring a frame having a reception power value less than the reception CCA threshold and decoding the frame having a reception power value equal to or greater than the reception CCA threshold,
wherein the reception CCA threshold is set to a value at which a frame addressed to its own BSS is easily decoded and a frame addressed to another BSS is easily ignored, on a basis of the reception environment.

8. A computer readable storage medium storing a CCA threshold determination program for determining a CCA threshold used in a wireless communication system including a plurality of wireless communicators configured by base stations or terminals, the program being computer-readable, and causing each of the wireless communicators to execute the CCA threshold determination method according to claim 7.
